(19) United States
(12) Patent Application Publication
(10) Pub. No.: US 2015/0331261 A1
(43) Pub. Date: Nov. 19, 2015

(54) METHOD OF PERSONALIZING EYEWEAR

(71) Applicant: Edward Mikolajczak, Seminole, FL (US)

(72) Inventor: Edward Mikolajczak, Seminole, FL (US)

(21) Appl. No.: 14/656,095

(22) Filed: Mar. 12, 2015

Related U.S. Application Data
(60) Provisional application No. 62/000,282, filed on May 19, 2014.

(51) Int. Cl. G02C 11/02; C09J 5/00

(52) U.S. Cl. CPC G02C 11/02; C09J 5/00

(57) ABSTRACT

A method of personalizing eyewear includes providing eyewear including a lens frame and a pair of temples. Each of the temples has an outer surface and the outer surfaces face away from each other when the temples are oriented parallel to each other and extending away from the lens frame. A plurality of decals is provided each having a first side, second side and a perimeter edge. An adhesive is provided is positioned on the first side of each of the decals. At least one of the decals is attached to the outer surface of one of the temples with the adhesive.

### BACKGROUND OF THE DISCLOSURE

1. Field of the Disclosure

The disclosure relates to eyewear personalizing devices and more particularly pertains to a new eyewear personalizing device for allowing a person to alter the appearance of eyewear.

2. Summary of the Disclosure

An embodiment of the disclosure meets the needs presented above by generally providing eyewear including a lens frame and a pair of temples. Each of the temples has an outer surface and the outer surfaces face away from each other when the temples are oriented parallel to each other and extending away from the lens frame. A plurality of decals is provided each having a first side, second side and a perimeter edge. An adhesive is provided is positioned on the first side of each of the decals. At least one of the decals is attached to the outer surface of one of the temples with the adhesive.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a method of personalizing eyewear according to an embodiment of the disclosure.

FIG. 2 is a perspective view of an embodiment of the disclosure.

FIG. 3 is a perspective in-use view of an embodiment of the disclosure.

FIG. 4 is a cross-sectional view of an embodiment of the disclosure taken along line 4-4 of FIG. 1.

### DESCRIPTION OF THE PREFERRED EMBODIMENT

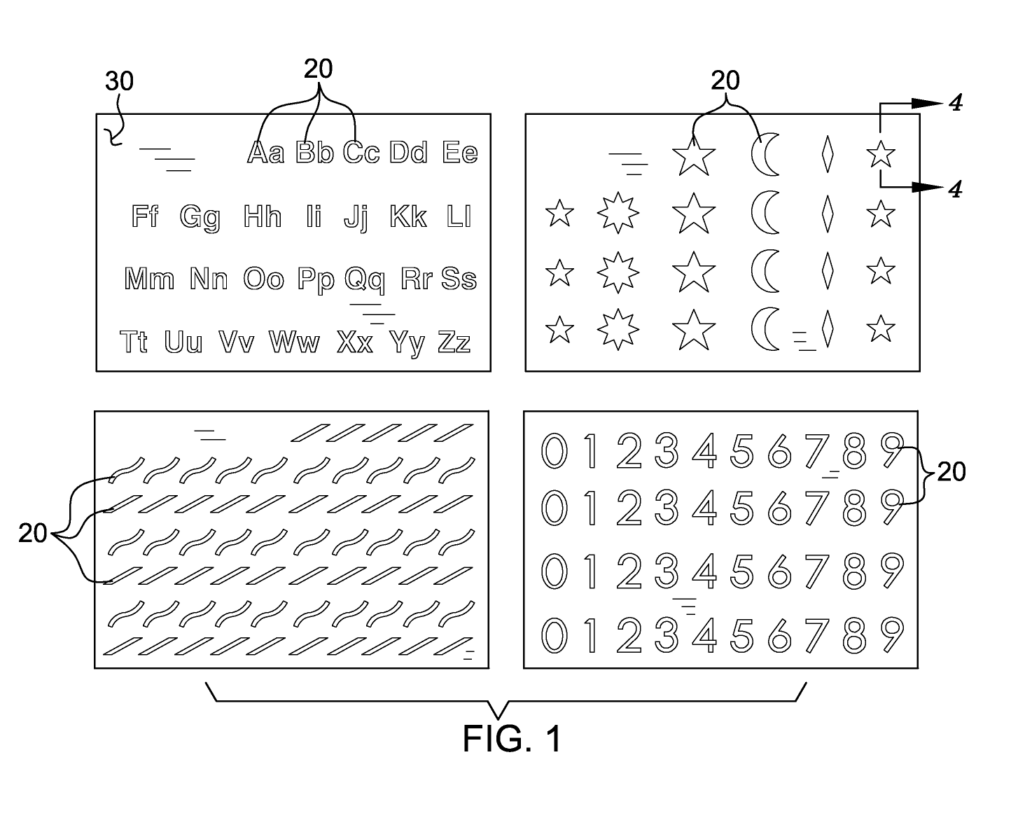

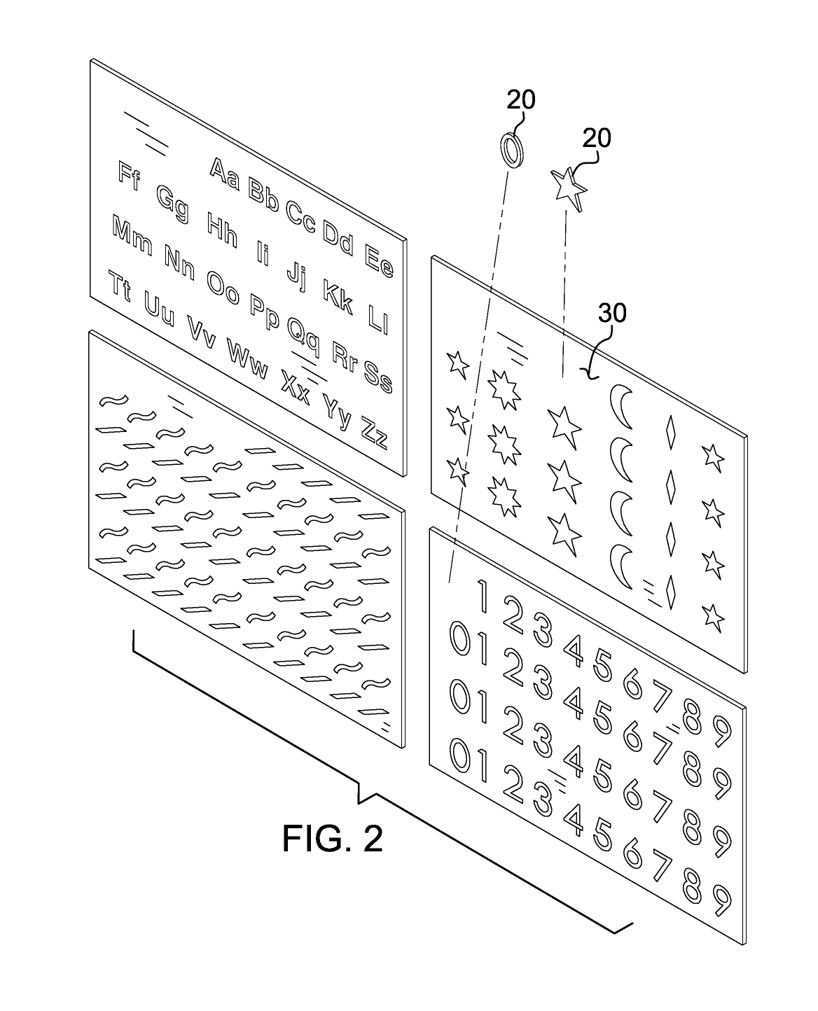

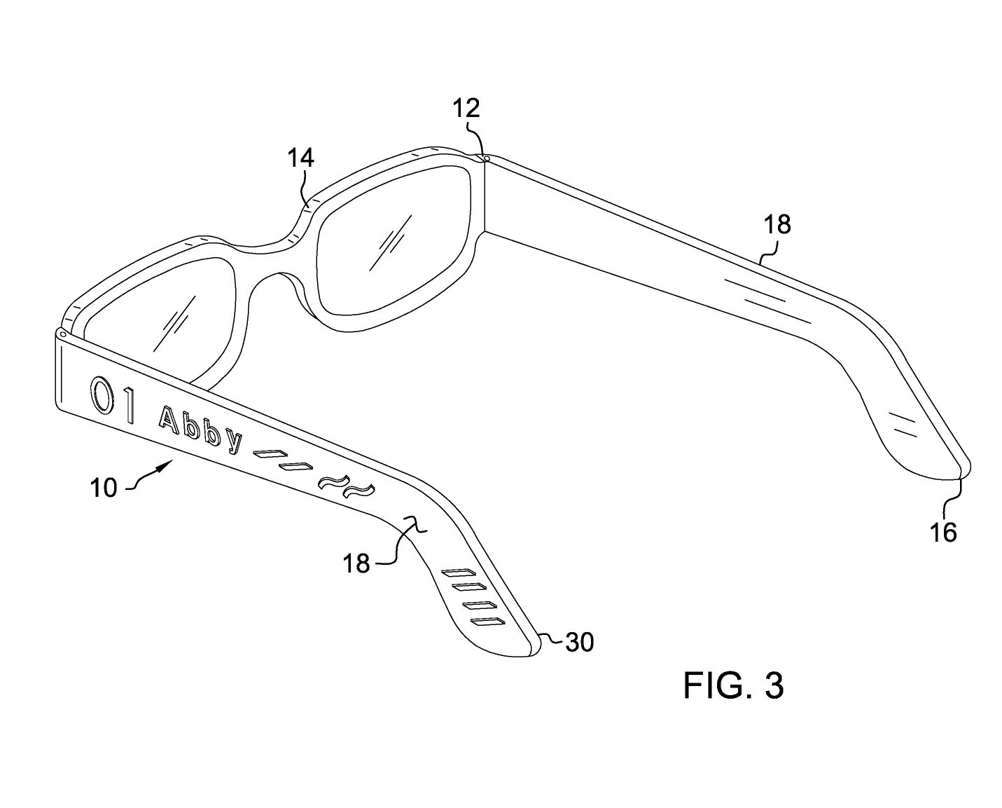

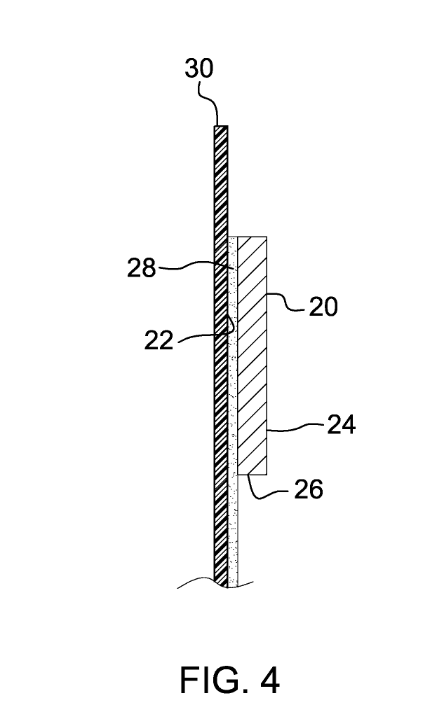

With reference now to the drawings, and in particular to FIGS. 1 through 4 thereof, a new eyewear personalizing device embodying the principles and concepts of an embodiment of the disclosure and generally designated by the reference numeral 10 will be described.

As best illustrated in FIGS. 1 through 4, the method of personalizing eyewear 10 generally includes placement of a plurality of decorative decals 20 on conventional eyewear 12. The eyewear 12 includes a lens frame 14 and a pair of temples 16. Each of the temples 16 has an outer surface 18 and the outer surfaces 18 face away from each other when the temples 16 are oriented parallel to each other and extending away from the lens frame 14.

The decals 20 each having a first side 22, second side 24 and a perimeter edge 26. Each of the first sides 22 has a height dimension and a width dimension. Each of the decals 20 has a height dimension is less than 0.5 inches to conform to a height dimension of the temples 16. Each of the decals 20 has a depth dimension from the first side 22 to the second side 24. The depth dimension of each decal is greater than 0.05 inches. As can be seen from the Figures, the decals 20 may comprise any number of artistic designs as well as alpha numeric characters. Artistic designs contemplated, for instance, may include geometrical shapes, animals, weather symbols, flags and the like. Additionally, the decals 20 may include color changing or phosphorescent features. The decals 20 having a depth dimension being greater than 0.05 inches improves the aesthetic feature of the decals 20 as they will be more easily visible.

An adhesive 28 is positioned on the first side 22 of each of the decals 20. The adhesive 28 may comprise any conventional adhesive and more particularly the adhesive 28 may be a pressure sensitive adhesive 28. The adhesive 28 may be permanent or may be one which requires a solvent for release.

A backing sheet 30 is provided and the decals 20 are each removably attached to the backing sheet 30. The backing sheet 30 comprises a non-stick material to allow for easy removal of the decals from backing sheet 30.

In use, at least one of the decals 20 is removed from the backing sheet 30 and attached to the outer surface 18 of one of the temples 16. It should be understood that multiple ones of the decals 20 may be removed and attached to one or both of the temples 16. The user may thereby customize the eyewear 12 as desired. Additionally, the decals 20 may be removed as desired and different decals 20 may be placed on the temples 16. In this manner the user may selectively alter the looks of the eyewear 12. While the decals 20 may be used in particular with eyewear 12, they may also be used with small electronics such as cellular phones and tablet computers, as well as other worn articles such as watches.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A method of personalizing eyewear, said method including the steps of:
providing eyewear including a lens frame and a pair of temples, each of said temples having an outer surface, said outer surfaces facing away from each other when said temples are oriented parallel to each other and extending away from said lens frame;
providing a plurality of decals, each of said decals having a first side, second side and a perimeter edge;
providing an adhesive being positioned on said first side of each of said decals; and
attaching at least one of said decals to said outer surface of one of said temples with said adhesive.

2. The method of personalizing eyewear according to claim 1, wherein the step of providing said plurality of decals further includes each of said decals having a height dimension being less than 0.5 inches, each of said decals having a depth dimension from said first side to said second side, said depth dimension being greater than 0.05 inches.

3. The method of personalizing eyewear according to claim 1, further including the steps of:
providing a backing sheet, said decals each being removably attached to said backing sheet;
removing at least one of said decals from said backing sheet before attaching said at least one of said decals to said outer surface.

4. A method of personalizing eyewear, said method including the steps of:
providing eyewear including a lens frame and a pair of temples, each of said temples having an outer surface, said outer surfaces facing away from each other when said temples are oriented parallel to each other and extending away from said lens frame;
providing a plurality of decals, each of said decals having a first side, second side and a perimeter edge, each of said first sides having a height dimension and a width dimension, each of said decals having a height dimension being less than 0.5 inches, each of said decals having a depth dimension from said first side to said second side, said depth dimension being greater than 0.05 inches;
providing an adhesive being positioned on said first side of each of said decals, said adhesive being a pressure sensitive adhesive;
providing a backing sheet, said decals each being removably attached to said backing sheet;
removing at least one of said decals from said backing sheet; and
attaching said at least one of said decals to said outer surface of one of said temples with said adhesive.
